(19) United States
(12) Patent Application Publication
(10) Pub. No.: US 2024/0227528 A9
(43) Pub. Date: Jul. 11, 2024

(54) MODEL OF AUTOMOTIVE SUNSHADE

(71) Applicant: Guangzhouyiqiandao Technology Co., Ltd, Guangzhou (CN)

(72) Inventor: Xinxing Yi, Shaoyang (CN)

(21) Appl. No.: 18/149,845

(22) Filed: Jan. 4, 2023

(30) Foreign Application Priority Data
Oct. 25, 2022 (CN) 202211308367.0

(51) Int. Cl. B60J 11/02

(52) U.S. Cl. CPC B60J 11/02

(57) ABSTRACT

A new model of automotive sunshade, comprises support bases, a housing, a right baffle, a left baffle, a bottom plate, sunshade cloths, storage cavities, storage reels, and connecting sliding strips; the support base is in movable connection with the bottom plate, whose both sides are provided with slideways, and through which the bottom plate is in sliding connection with the housing; the left and right sides of the housing are respectively provided with a right baffle and a left baffle, which are respectively provided with slots; the housing is provided with two storage cavities arranged symmetrically on the front and rear sides, the storage reel is arranged inside the storage cavity, a sliding track is arranged on the storage reel, and a connecting sliding strip is arranged inside the sliding track.

### 1. TECHNICAL FIELD

The application relates to the field of automotive supplies, in particular to a new model of automotive sunshade.

### 2. BACKGROUND ART

Nowadays, car ownership in China has grown very rapidly. Due to the scarcity of urban space, it is hard to build enough garages to park vehicles, for which many people have to park their vehicles on the roadside and outdoors. Every time in summer, the scorching sun continuously shines on the vehicles parked outdoors. Due to the high heat storage capacity of the metal housing of the vehicles, each vehicle is like an oven after a long period of exposure to the sun, which also intensifies the urban heat island effect.

The continuous heat increases the temperature inside the vehicle, even reaching above 60° C. Under such temperature, vehicle interior materials will continue to volatilize harmful substances, which will still be inhaled into the human body even after opening the door for ventilation, causing damage to human health.

In addition, the continuous exposure to the sun will cause serious aging of the internal and external materials of the vehicle, which not only increases the waste caused by replacing parts, but more seriously may cause the internal circuit of the vehicle to catch fire, causing the vehicle to spontaneously ignite and cause major accidents. Therefore, how to keep the vehicles parked outdoors from being exposed to the sun has become an urgent problem to be solved.

Aiming at the above problems, the prior art provides some solutions, such as setting a windshield sunshade device that can be stretched on the roof of the vehicle. Although it can provide shade for the vehicle, the device is inconvenient when unfolded and stored, and it is time-consuming and laborious to settle and store.

### 3. SUMMARY OF THE APPLICATION

The technical problem to be solved by the invention is to overcome the defects of the above technologies and provide a new model of automotive sunshade.

In order to solve the above technical problems, the technical solution provided by the invention is a new model of automotive sunshade, comprising support bases, a housing, a right baffle, a left baffle, a bottom plate, sunshade cloths, storage cavities, storage reels, and connecting sliding strips; the support base is in movable connection with the bottom plate, slideways are provided on both sides of the bottom plate, and the bottom plate is in sliding connection with the housing through slideways; the left and right sides of the housing are respectively fixedly connected with the right baffle and the left baffle, both the right baffle and the left baffle are provided with symmetrical slots with one end open, the right baffle and the left baffle are provided with a guide rod respectively, and each guide rod is provided with a connecting hole;
the housing is provided with two storage cavities arranged symmetrically on the front and rear sides; the storage reel is arranged inside the storage cavity, a sliding track is arranged on the storage reel, and a movable connecting sliding strip is arranged inside the sliding track; one end of the sunshade cloth is wound and fixed on the connecting sliding strip, and connected with the storage reel through the sliding track; the inside of the storage cavities of the housing are respectively provided with sliding tracks, and the other end of the sunshade cloth is wound and connected with the connecting sliding strip in the sliding track; the storage reel is hollow, the storage reel is provided with an extension rod, and the extension rod can move linearly along the axis direction of the storage reel;
the right baffle and the left baffle are respectively provided with movably connected telescopic rods, the telescopic rods are located between the two storage cavities, the opposite sides of the two telescopic rods are respectively provided with abutting springs, and an intermediate baffle is provided between the two springs.

Furthermore, the support base comprises suction cups, a bracket, connecting members; the bottom of the bracket is fixedly connected with suction cups, the top of the bracket is provided with the connecting members that are in sliding connection to both sides of the bottom plate, and the bracket and the connecting member are integrally formed.

Furthermore, a movable cleaning rod is arranged on the left baffle.

Furthermore, stoppers are respectively provided on both sides of the storage reel.

Furthermore, the right baffle and the left baffle are respectively provided with a reset button; each of the reset buttons is provided with a fixedly connected ejector rod, the ejector rod abuts against one end of a locking member, the other end of the locking member abuts against the groove provided on the telescopic rod, the locking member is provided with a locking member spring and a connecting shaft connected in rotation, the connecting shaft is connected with the guide rod through the connecting hole on the guide rod.

Compared with the prior art, the advantages of the application are: The structure design of this device is reasonable and convenient to use. When in use, it can be fixed on the top of the vehicle through the suction cups, and the distance between the two support bases can be adjusted by moving the connecting part of the support base on the bottom plate. Then the storage reel can be pulled to drive the sunshade cloth to unfold, which can provide shelter for vehicles parked outdoors, avoiding the problem of high temperature inside the vehicle caused by the continuous sun shining, and reducing the cost of replacing the aging inner and outer parts of the vehicle due to the sunshine. More importantly, it avoids various safety hazards caused by long-term exposure to the sun.

### 4. BRIEF DESCRIPTION OF ACCOMPANY DRAWINGS

FIG. 1 is a perspective view of a new model of automotive sunshade according to the invention;

FIG. 2 is a partial structural schematic diagram of the new model of automotive sunshade according to the invention;

FIG. 3 is an internal structural schematic diagram of the new model of automotive sunshade according to the invention;

FIG. 4 is a sectional view of the new model of automotive sunshade according to the invention;

FIG. 5 is a structural schematic diagram of the storage reel of the new model of automotive sunshade according to the invention;

FIG. 6 is an enlarged view of part A in FIG. 5 of the new model of automotive sunshade according to the invention;

FIG. 7 is a structural schematic diagram of the telescopic rod of the new model of automotive sunshade according to the invention;

FIG. 8 is an enlarged view of part B in FIG. 7 of the new model of automotive sunshade according to the invention;

FIG. 9 is a structural schematic diagram of the baffle of the new model of automotive sunshade according to the invention;

FIG. 10 is a schematic diagram of the using effect of the new model of automotive sunshade according to the invention.

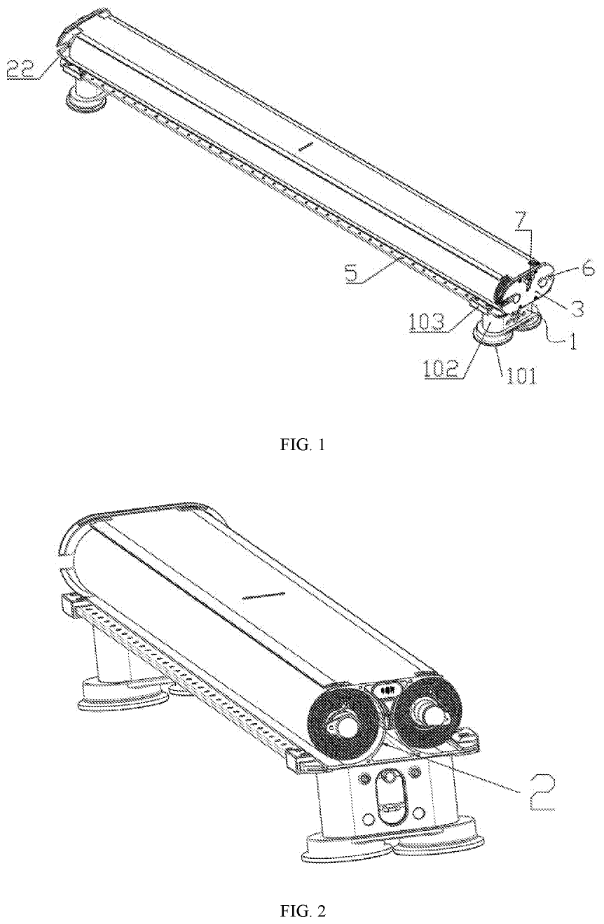

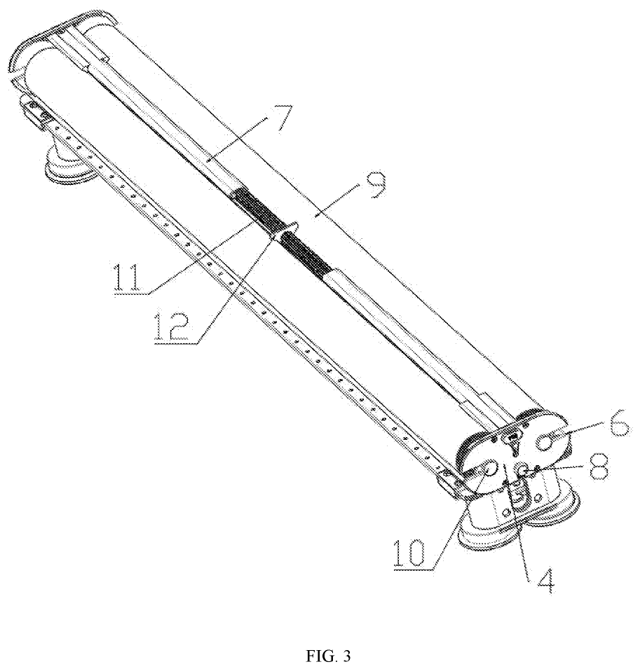

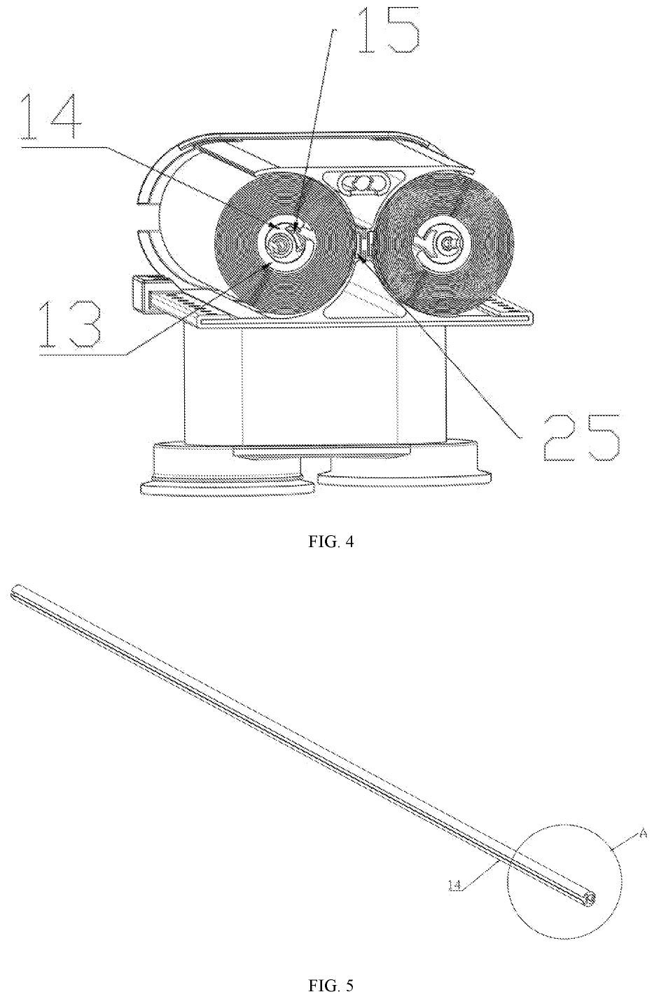

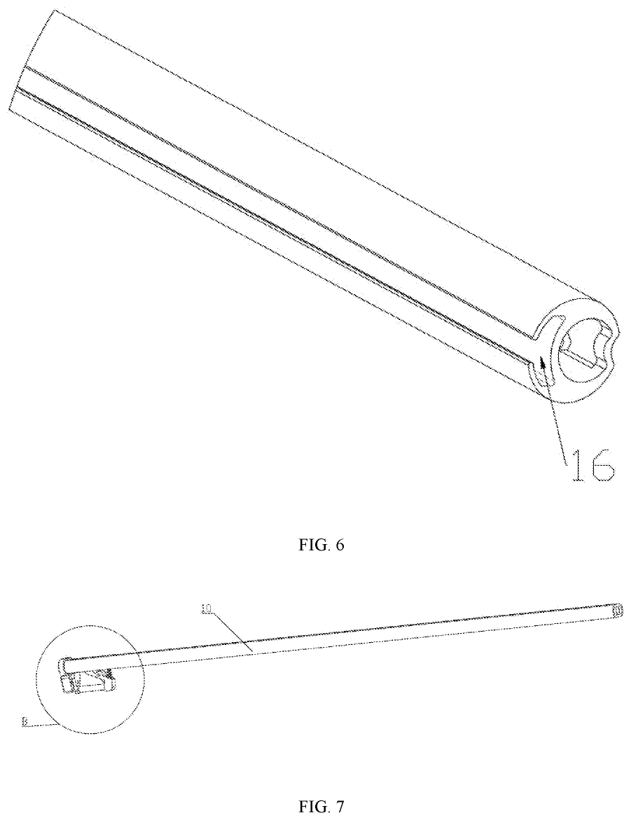

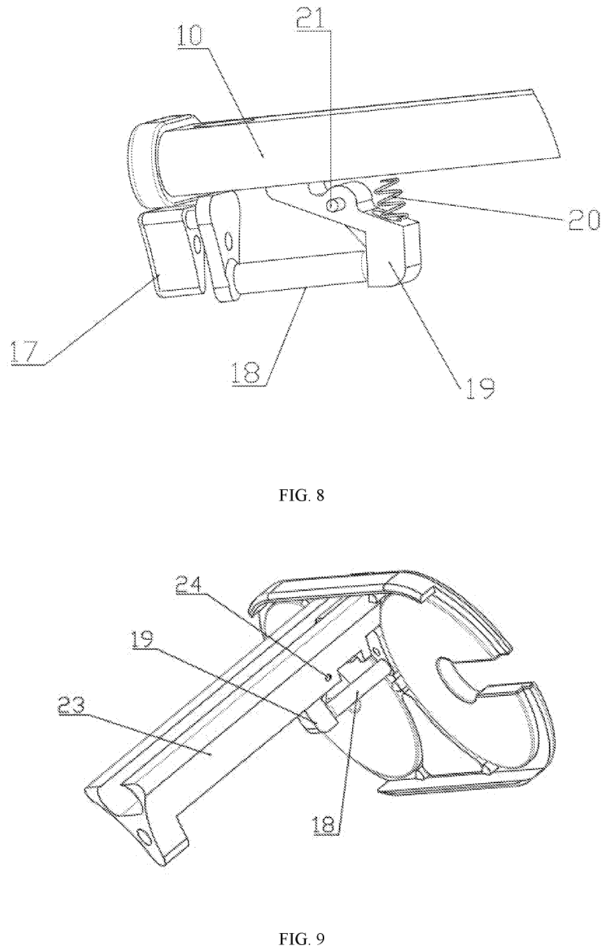

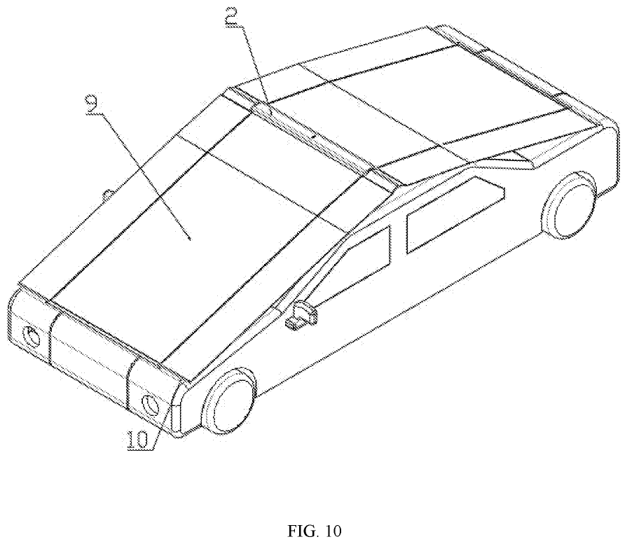

As shown in the figures, 1 refers to the support base, 101 refers to the suction cup, 102 refers to the bracket, 103 refers to the connecting member, 2 refers to the housing, 3 refers to the right baffle, 4 refers to the left baffle, 5 refers to the bottom plate, 6 refers to the slot, 7 refers to the telescopic rod, 8 refers to the cleaning rod, 9 refers to the sunshade cloth, 10 refers to the extension rod, 11 refers to the spring, 12 refers to the intermediate baffle, 13 refers to the storage cavity, 14 refers to the storage reel, 15 refers to the connecting sliding strip, 16 refers to the sliding track, 17 refers to the reset button, 18 refers to the ejector rod, 19 refers to the locking member, 20 refers to the locking member spring, 21 refers to the connecting shaft, 22 refers to the stopper, 23 refers to the guide rod, 24 refers to the connecting hole, 25 refers to the connecting mechanism.

### 5. SPECIFIC EMBODIMENT OF THE APPLICATION

With reference to the drawings, a new model of automotive sunshade of the invention is further described in detail hereinafter.

With reference to the drawings, a new model of automotive sunshade, comprises support bases 1, a housing 2, a right baffle 3, a left baffle 4, a bottom plate 5, sunshade cloths 9, storage cavities 13, storage reels 14, and connecting sliding strips 15; the support base 1 is movably connected with the bottom plate 5, slideways are provided on both sides of the bottom plate 5, and the bottom plate 5 is in sliding connection with the housing 2 through slideways; the left and right sides of the housing 2 are respectively fixedly connected with the right baffle 3 and the left baffle 4, both the right baffle 3 and the left baffle 4 are provided with symmetrical slots 6 with one end open, the right baffle 3 and the left baffle 4 are provided with a guide rod 23 respectively, and each guide rod 23 is provided with a connecting hole 24;
the housing 2 is provided with two storage cavities 13 arranged symmetrically on the front and rear sides; the storage reel 14 is arranged inside the storage cavity 13, a sliding track 16 is arranged on the storage reel 14, and a movable connecting sliding strip 15 is arranged inside the sliding track 16; one end of the sunshade cloth 9 is wound and fixed on the connecting sliding strip 15, and connected with the storage reel 14 through the sliding track 16; the inside of the storage cavities 13 of the housing 2 are respectively provided with sliding tracks 16, and the other end of the sunshade cloth 9 is wound and connected with the connecting sliding strip 15 in the sliding track 16; the storage reel 14 is hollow, the storage reel 14 is provided with an extension rod 10, and the extension rod 10 can move linearly along the axis direction of the storage reel 14;
the right baffle 3 and the left baffle 4 are respectively provided with movably connected telescopic rods 7, the telescopic rod 7 is located above the middle of the two storage cavities 13, the opposite sides of the two telescopic rods 7 are respectively provided with abutting springs 11, and an intermediate baffle 12 is provided between the two springs 11.

As a preferred scheme of the embodiment, the support base 1 comprises suction cups 101, a bracket 102, connecting members 103; the bottom of the bracket 102 is fixedly connected with suction cups 101, the top of the bracket 102 is provided with the connecting members 103 that are in sliding connection to both sides of the bottom plate 5, and the bracket 102 and the connecting member 103 are integrally formed.

As a preferred scheme of the embodiment, a movable cleaning rod 8 is arranged on the left baffle 4.

As a preferred scheme of the embodiment, stoppers 22 are respectively provided on both sides of the storage reel 14.

As a preferred scheme of the embodiment, the right baffle 3 and the left baffle 4 are respectively provided with a reset button 17; each of the reset buttons 17 is provided with a fixedly connected ejector rod 18, the ejector rod 18 abuts against one end of a locking member 19, the other end of the locking member 19 abuts against the groove provided on the telescopic rod 7, the locking member 19 is provided with a locking member spring 20 and a connecting shaft 21 connected in rotation, the connecting shaft 21 is connected with the guide rod 23 through the connecting hole 24 on the guide rod 23.

In specific implementation of the invention, when in use, the device can be fixed on the roof of the vehicle through the suction cups 101. The bottom plate 5 is made of soft rubber, which is used to prevent damage to the vehicle body when the device collides with the vehicle body. Meanwhile, the connecting members 103 of the support base 1 can move along both sides of the bottom plate 5, thereby adjusting the distance between the two support bases 1 to meet the installation requirements of vehicles of different widths.

When the sunshade cloths 9 need to be unfolded, first loosen the stoppers 22 on both sides, then pull out the extension rods 10 on both sides, compress the stoppers 22 to prevent the extension rods 10 from sliding, hold the sunshade cloths rolled up on the storage reels 14 and the extension rods 10 on both sides respectively, and pull them towards the front or rear of the vehicle, driving the umbrella cloths 9 to unfold. Then press the reset buttons 17, making the telescopic rods 7 stretch out under the action of the spring 11, and the telescopic rods 7 will be fixed under the locking action of the locking members 19. Then the sunshade cloths 9 are respectively connected with the extension rods 10 and the telescopic rods 7 to realize the full expansion of the sunshade cloths 9. Finally, fix the storage reels 14 to the front or the rear of the vehicle respectively with ropes, providing shelters for the vehicle parked outdoors.

When the sunshade cloths 9 need to be folded, first untie the rope that fixes the front and rear of the vehicle, disconnect the sunshade cloths 9 from the extension rods 10 and the telescopic rods 7, then hold the storage reels 14 close to the operator's body and the extension rods 10 to roll the sunshade cloths 9 toward the middle of the vehicle body, thereby realizing the retraction and storage of sunshade cloths 9. After the extension rods 10 return to the round holes of the right baffle 3 and left baffle 4 on both sides, release the stoppers 22, retract the extension rods 10, then fix the stoppers 22 to prevent the extension rods 10 from sliding out and cause the storage reels 14 to slip out of the housing 2. Then press the reset buttons 17, the locking members 19 will break away from the abutment with the telescopic rods 7 under the action of the ejector rods 18, and the telescopic rods 7 can be retracted.

When sundries such as leaves and bird droppings fall on the sunshade cloths 9, the cleaning rod 8 can be pulled out to clean the sundries attached to the sunshade cloths 9.

The device structure provides shelter for vehicles parked outdoors, avoiding the problem of high temperature inside the vehicle caused by the continuous sun shining, and reducing the cost of replacing the aging inner and outer parts of the vehicle due to the sunshine. More importantly, it avoids various safety hazards caused by long-term exposure to the sun. Additionally, its usage and storage are both convenient, saving time as well as effort.

The invention and its embodiments have been described above, but the description is not restrictive. What is shown in the accompanying drawings is only one of the embodiments of the invention, and the actual structure is not limited thereto. All in all, if those of ordinary skill in the art are inspired, without departing from the purpose of the invention, any structural modes and embodiments similar to this technical solution designed without creativity should fall within the protection scope of the invention.

1. A new model of automotive sunshade, comprises support bases (1), a housing (2), a right baffle (3), a left baffle (4), a bottom plate (5), sunshade cloths (9), storage cavities (13), storage reels (14), and connecting sliding strips (15); the support base (1) is in movable connection with the bottom plate (5), slideways are provided on both sides of the bottom plate (5), and the bottom plate (5) is in sliding connection with the housing (2) through slideways; the left and right sides of the housing (2) are respectively fixedly connected with the right baffle (3) and the left baffle (4), both the right baffle (3) and the left baffle (4) are provided with symmetrical slots (6) with one end open, the right baffle (3) and the left baffle (4) are provided with a guide rod (23) respectively, and each guide rod (23) is provided with a connecting hole (24);
the housing (2) is provided with two storage cavities (13) arranged symmetrically on the front and rear sides; the storage reel (14) is arranged inside the storage cavity (13), a sliding track (16) is arranged on the storage reel (14), and a movable connecting sliding strip (15) is arranged inside the sliding track (16); one end of the sunshade cloth (9) is wound and fixed on the connecting sliding strip (15), and connected with the storage reel (14) through the sliding track (16); the inside of the storage cavities (13) of the housing (2) are respectively provided with sliding tracks (16), and the other end of the sunshade cloth (9) is wound and connected with the connecting sliding strip (15) in the sliding track (16); the storage reel (14) is hollow, the storage reel (14) is provided with an extension rod (10), and the extension rod (10) can move linearly along the axis direction of the storage reel (14);
the right baffle (3) and the left baffle (4) are respectively provided with movably connected telescopic rods (7), the telescopic rods (7) are located between the two storage cavities (13), the opposite sides of the two telescopic rods (7) are respectively provided with abutting springs (11), and an intermediate baffle (12) is provided between the two springs (11).

2. The new model of automotive sunshade according to claim 1, wherein the support base (1) comprises suction cups (101), a bracket (102), connecting members (103); the bottom of the bracket (102) is fixedly connected with suction cups (101), the top of the bracket (102) is provided with the connecting members (103) that are in sliding connection to both sides of the bottom plate (5), and the bracket (102) and the connecting member (103) are integrally formed.

3. The new model of automotive sunshade according to claim 1, wherein a movable cleaning rod (8) is arranged on the left baffle (4).

4. The new model of automotive sunshade according to claim 1, wherein stoppers (22) are respectively provided on both sides of the storage reel (14).

5. The new model of automotive sunshade according to claim 1, wherein the right baffle (3) and the left baffle (4) are respectively provided with a reset button (17); each of the reset buttons (17) is provided with a fixedly connected ejector rod (18), the ejector rod (18) abuts against one end of a locking member (19), the other end of the locking member (19) abuts against the groove provided on the telescopic rod (7), the locking member (19) is provided with a locking member spring (20) and a connecting shaft (21) connected in rotation, the connecting shaft (21) is connected with the guide rod (23) through the connecting hole (24) on the guide rod (23).
